(19) United States
(12) Patent Application Publication
(10) Pub. No.: US 2022/0348505 A1
(43) Pub. Date: Nov. 3, 2022

(54) CERAMIC POWDER FOR TIMEPIECE

(71) Applicant: ROLEX SA, Geneva (CH)

(72) Inventors: Cyriaque Boccard, Douvaine (FR); Laurent Mincone, Jonzier-Epagny (FR); Ollivier Pujol, Lausanne (CH)

(73) Assignee: ROLEX SA, Geneva (CH)

(21) Appl. No.: 17/865,599

(22) Filed: Jul. 15, 2022

Related U.S. Application Data
(62) Division of application No. 15/955,995, filed on Apr. 18, 2018.

(30) Foreign Application Priority Data
Apr. 20, 2017 (EP) 17167235.5

(51) Int. Cl. C04B 35/488; G04B 37/22; C04B 35/48; C04B 35/628; C01F 7/02; C04B 35/638; C04B 35/634; A44C 27/00; C04B 35/111; C04B 35/626; C04B 35/44; C01G 25/02; C22C 29/12; C04B 35/486; C01F 7/166; C04B 41/45; C04B 35/117; C04B 35/10; C04B 35/119; C04B 35/64

(52) U.S. Cl. CPC C04B 35/4885; G04B 37/22; C04B 35/48; C04B 35/62842; C01F 7/02; C04B 35/638; C04B 35/63488; A44C 27/001; C04B 35/111; C04B 35/62655; C04B 35/63416; C04B 35/44; G04B 37/225; C01G 25/02; C22C 29/12; C04B 35/486; C04B 35/6261; C04B 35/62884; C01F 7/166; C04B 41/45; C04B 35/117; C04B 35/10; C04B 35/119; C04B 35/488; C04B 35/64; C04B 2235/408; C04B 2235/3217; C04B 2235/3225; C01P 2002/50; C04B 2235/6022; C01P 2006/63; C04B 2235/3213; C04B 2235/6567; C01P 2006/64; C04B 2235/604; C04B 2235/6023; C01P 2002/52; C04B 2235/3222; C04B 2235/602; C04B 2235/60; C01P 2006/62; C04B 2235/9661

(57) ABSTRACT

A ceramic powder for a ceramic component, in particular based on zirconia and/or alumina, in particular for a timepiece or jewelry piece. The powder includes at least one noble metal among platinum, rhodium, osmium, palladium, ruthenium and iridium, at a quantity of less than or equal to 5% by weight.

### INTRODUCTION

This application is a divisional of U.S. application Ser. No. 15/955,995 filed Apr. 18, 2018, the content of which is hereby incorporated by reference herein in its entirety. This application claims priority of European patent application No. EP17167235.5 filed Apr. 20, 2017, the content of which is hereby incorporated by reference herein in its entirety.

The present invention relates to a ceramic component. A ceramic component of this kind finds applications in horology and jewelry. In particular, a component of this kind finds applications in a timepiece, in particular for decorative components such as a bezel, or functional components such as movement parts.

### PRIOR ART

In the field of horology, just as in jewelry, it is known to use components made of ceramic, in particular decorative components. However, the use of these ceramic components is limited owing to the fact that it is difficult or even impossible to obtain certain colors, in particular certain gray hues, and difficult to obtain an even, predictable and reproducible color. Furthermore, obtaining a particular hue requires the production of an entire batch of material from the initial components, and proves time-consuming and complex.

Another limiting factor is also the difficulty in testing the effect of the addition of certain elements, which can combine with the constituents of known ceramics, in particular to obtain certain particular mechanical characteristics of the ceramic component. Here, too, each test is complex and requires the production of an entire batch of material from the initial components.

The usual process for manufacturing a ceramic component comprises a first phase of preparing the primary material, that is to say the ceramic powder, such as a zirconia- and/or alumina-based ceramic powder. In this first phase, this primary material is generally prepared in the form of a ceramic powder to which it is possible to add, for example, other oxides in order to strengthen the ceramic component, or pigments in order to obtain a colored material. The pigments are generally of the metal oxide type or the rare earth oxide type, and are added to and mixed with the base ceramic powder by a liquid method, the pigments being thus introduced using a carrier liquid.

A second phase of the process for manufacturing a ceramic component is to add a binder to the ceramic powder obtained in the first phase. A binder of this kind generally consists of one or more organic compounds. The nature and proportion of the binder depend on the intended process in a third phase, and at the end of this phase one can refer in general terms to a binded ceramic powder.

The third phase consists in shaping the ceramic component. To that end, a first approach comprises a step of pressing a cluster of binded particles obtained at the end of the second phase: in such a process, the second phase prepares a binded ceramic powder in the form of atomized granules for pressing. A second approach is shaping by injection into a mold. In such a case, the preparation resulting from the second phase is a binded ceramic powder referred to as the “feedstock”. A third approach is shaping by casting into a mold, commonly referred to as slip casting. In such a case, the preparation resulting from the second phase is a binded ceramic powder in suspension, referred to as slip or also “slurry”. At the end of the third phase, the ceramic component has a shape which is close to its final shape and contains both the ceramic powder and the binder. Other shaping techniques such as gel casting, freeze casting or coagulation casting techniques may be used.

A fourth phase allows the ceramic component to be finished. This fourth phase comprises a first step of debinding the component, that is to say eliminating the binder, for example using a thermal treatment or using a solvent. A second step allows the component to be compacted, eliminating the pores left by removal of the binder. This second step is generally a thermal sintering treatment (firing at high temperature). The final color of the ceramic component, as well as its final mechanical properties, appear only at the end of this fourth phase and are the result of the reactions between the various constituents of the component but also the atmosphere present in the furnace, which come into play during the thermal treatment. These reactions are complex and sometimes unpredictable.

It can be seen that the traditional process for manufacturing a ceramic component, detailed above, has several drawbacks. In particular, the color and the final properties obtained are dependent on numerous parameters such as the microstructure of the powder formed in the first phase, in particular the size of the grains of powder, the size of the pigments, their reactivity with the ceramic and the sintering environment, etc. It is further dependent on all of the other factors linked to the other phases of manufacturing, such as the size and number of pores in the final component, the composition of the grain boundaries, the density, the percentage of the one or more pigments and their distribution within the matrix, any possible combination between these pigments or between these pigments and the constituents of the primary ceramic material or the atmosphere during sintering, the chemical purity of the initial compounds and the possible presence of intrinsic and extrinsic contaminants. This multiplicity of parameters to be taken into account makes it difficult to predict and reproducibly obtain a certain desired color. This is even more true if the quantity of coloring pigments is small: thus, to mitigate this drawback, all of the existing processes necessarily use a large quantity of pigments. Furthermore, certain processes attempt to improve the result by adding steps based on complex chemistry, which of course has the drawback of further complicating the manufacturing process.

What is more, the difficulty in managing the colors of a ceramic component makes it necessary, in practice, to carry out numerous tests, which involves producing numerous complete samples, from the preparation of the binded ceramic powder up to the final shaping, while varying some of the above-mentioned parameters for each sample in order to determine the optimal process. Furthermore, if one wishes to modify a color, even slightly, it is necessary to start the entire process from the very beginning, including, once again, preparing numerous samples. Thus, in practice, the search for a controlled color for a ceramic component, which is often necessary for the use thereof as a decorative element, requires complex and laborious development steps.

Finally, in spite of the numerous tests, it has been observed, nowadays, that it appears to be impossible to obtain, and this is even more the case in industrial contexts, ceramic components having certain colors, in particular certain gray colors such as those defined by CIE L*a*b* color coordinates (83; 0; 0.6) and CIE L*a*b* color coordinates (47; 0.2; −0.2). Generally, a color defined for example by a* and b* parameters close to 0 and an L* parameter less than 96, in particular a strictly gray color, is impossible to obtain.

Thus, the present invention has the general object of proposing a solution for manufacturing a ceramic component, in particular for a timepiece, which does not have the drawbacks of the prior art.

More precisely, a first object of the present invention is to propose a solution for manufacturing a ceramic component which makes it possible to obtain a ceramic having improved properties, in particular one whose color is controlled.

A second object of the present invention is to propose a solution for the simplified manufacturing of a colored ceramic component.

A third object of the present invention is to propose a gray ceramic.

A fourth object of the present invention is to propose a simple method for modifying a ceramic powder that may already be colored in order to modify the resulting color of the finished ceramic component.

### BRIEF DESCRIPTION OF THE INVENTION

To that end, the invention rests on a ceramic component, in particular based on zirconia and/or alumina or strontium aluminate, for a timepiece or jewelry piece, comprising at least one noble metal among platinum, rhodium, osmium, palladium, ruthenium and iridium, at a quantity of less than or equal to 5% by weight.

The invention is defined more precisely by the claims.

### BRIEF DESCRIPTION OF THE FIGURES

These objects, features and advantages of the present invention will be disclosed in detail in the following non-limiting description of a particular embodiment, with reference to the appended figures, in which:

FIG. 1 shows, schematically, a flow chart of the steps of the process for manufacturing a component made of colored ceramic for a timepiece, according to one embodiment of the present invention.

FIG. 2 shows a ceramic component obtained according to a first example, according to one embodiment of the invention.

FIG. 3 shows a ceramic component obtained according to a second example, according to one embodiment of the invention.

FIG. 4 shows a ceramic component obtained according to a third example, according to one embodiment of the invention.

FIG. 5 shows a ceramic component obtained according to a fourth example, according to one embodiment of the invention.

FIG. 6 shows the change in clarity as a function of the platinum content for the ceramic components of examples 4 to 7, obtained by one embodiment of the invention.

FIG. 7 shows the change in the a* chromaticity parameter as a function of the platinum content for the ceramic components of examples 4 to 7, obtained by one embodiment of the invention.

FIG. 8 shows the change in the b* chromaticity parameter as a function of the platinum content for the ceramic components of examples 4 to 7, obtained by one embodiment of the invention.

FIG. 9 shows a ceramic component obtained according to an example, according to one embodiment of the invention.

FIG. 10 shows a ceramic component obtained according to another example, according to one embodiment of the invention.

In the following, a ceramic component is defined as a component made of a dense polycrystalline material comprising principally at least one ceramic, in particular one based on zirconia and/or alumina and/or strontium aluminate, for example a zirconia stabilized with yttrium oxide and/or cerium oxide and/or magnesium oxide and/or calcium oxide. A ceramic powder is defined as a powder in the form of a finely divided solid, consisting of fine particles of ceramic, in particular one based on zirconia and/or alumina and/or strontium aluminate. In order to simplify the description, it has been decided to retain the same term of ceramic powder, in a widened sense, for a powder principally comprising fine particles of ceramic, but also other added elements such as one or more pigments, or oxides whose purpose is to strengthen the ceramic, such as yttrium oxide. Accordingly, the ceramic powder or ceramic component comprises mostly a component or several elements of ceramic type, in all embodiments, i.e. at least 50% by weight of this component or several elements of ceramic type, or even at least 75%, or even at least 90%. By way of example, the ceramic powder or ceramic component comprises at least 50% of zirconia.

In all cases, a ceramic powder contains no organic compound. The generic term “binded ceramic powder” designates a composite material consisting of a ceramic powder and a binder which generally consists of one or more organic compounds, in variable proportions, and intended for the shaping of a part by pressing, by injection, by casting or by other techniques.

The term “(pressing) granule” designates a cluster of binded ceramic powder, intended to be shaped by a pressing process, for example cold or hot uniaxial pressing, or cold or hot isostatic pressing. A granule generally comprises between 1% and 4% inclusive by weight of organic compounds.

The term “injectable ceramic powder”, also generally known as “feedstock”, designates a binded ceramic powder intended to be shaped by a high- or low-pressure injection process. An injectable ceramic powder generally comprises between 12% and 25% inclusive by weight of organic compounds.

The term “slurry” designates a binded ceramic powder intended to be shaped by slip casting or gel casting. A slurry generally comprises between 1% and 25% inclusive by weight of organic compounds.

The process for manufacturing a ceramic component according to an embodiment of the invention comprises the phases and steps shown schematically by the flow chart of FIG. 1.

This manufacturing process thus comprises the usual phases P1 to P4 of the process, that is to say the preparation of the ceramic powder (P1), the addition of a binder (P2), the shaping of the component (P3) and the thermal treatment of debinding and sintering (P4). The traditional parts of these phases will not be listed at this stage since they are known from the prior art. Hence, a person skilled in the art will be able to implement them, including according to any existing variants or equivalences.

The embodiment of the invention differs from the traditional process in particular by the addition of a step E3 of depositing at least one additional element or compound, for example a coloring element, by a dry method.

According to a first variant embodiment, the deposition step E3 consists of physical vapor deposition (PVD) and/or chemical vapor deposition (CVD).

According to a second variant embodiment, the deposition step E3 consists of atomic layer deposition (ALD).

This deposition step E3 is implemented on a binded or unbinded ceramic powder, that is to say after the first phase P1 or after the second phase P2 of the manufacturing process. It can thus be implemented on a ceramic powder comprising only particles of ceramic or on a ceramic powder comprising organic compounds, for example on a granule or on injection feedstock. It is implemented before the third phase P3 of the process. In order to simplify the description, hereinafter a ceramic powder, binded or not, shall be the ceramic powder comprising one or more additional elements or compounds, obtained by implementation of the deposition step E3 of the invention.

The additional element or compound can be one of a wide variety, in particular a metal, an oxide, a nitride or a carbide. Metal is understood to refer to a pure metal or an alloy. It can thus advantageously be a metal-based compound. For the sake of simplicity, the remainder of the document will use the terms additional element or additional compound without distinction, whether fora single element, a compound or an alloy.

The invention is novel in that it permits the use of metals which could not be used with the existing solutions, such as the noble metals having a high melting point of greater than or equal to 1200° C., or even greater than or equal to 1500° C. Thus, the invention makes it possible to use, as additional element, platinum, rhodium, osmium, palladium, ruthenium or iridium.

Thus, an additional compound can be a metal alloy obtained by direct deposition of the metal alloy onto the binded or unbinded ceramic powder, or by combining successive or simultaneous depositions of several of the elements of the metal alloy onto the binded or unbinded ceramic powder.

Naturally, multiple different additional elements or compounds can be used and deposited onto the same ceramic powder, simultaneously or successively, by one or more deposition steps E3 as described above. This increase in the available additional compounds obviously makes it possible to increase the possible colors for a ceramic, as well as the other possible properties, in particular mechanical or tribological.

It is noted that a person skilled in the art will usually add color pigments to a ceramic by liquid means. It is not usual for a person skilled in the art to do so by a dry method, or to deposit directly onto a binded or unbinded ceramic powder. In the context of deposition by a dry method, the following parameters must be taken into account:
the homogeneity of the deposition onto the powders,
the homogeneity of shape and size of the grains of powder,
the temperatures of the process,
the risk of outgassing,
the electrostatic character of (insulating) moving divided solids,
the finish and nature of the materials of the equipment; it is in particular necessary to correctly select the pairing between the nature of the deposit and the nature of the binders of the granules in order to prevent the powder sticking to the equipment.

For example, in the context of PVD deposition, in order to reduce the risk of the powder agglomeration inside a PVD chamber owing to the small particle sizes but also due to their electrostatic nature, the deposition is advantageously carried out on the binded ceramic powder, for example on granules for pressing (having an average size of the order of several tens of microns) or on injectable ceramic powders in the form of pellets (having an average size of the order of several millimeters) which are larger. Thus, this approach presents a mixed substrate comprising a ceramic powder and organic compounds having poor thermal integrity, a maximum temperature being 45° C.

Furthermore, it can be seen that the process of the invention makes it possible to achieve very satisfactory results, with respect to the novel or improved properties of the ceramic components, even with very small quantities of additional compound added to the ceramic. Thus, the color of a ceramic component is not only improved compared to the existing solutions in that it is homogeneous and/or can permit new hues, but moreover this improved result is obtained by adding very small quantities of an additional coloring element or compound, in particular in quantities much lower than the quantity of coloring pigments used with the traditional method.

For example, the PVD deposition process is used with a proportion by weight of additional element or compound of less than or equal to 5%, or even less than or equal to 3%, or even 2%. Advantageously, this proportion is greater than or equal to 0.01%. Advantageously, this proportion is between 0.01% and 5% inclusive, or even between 0.01% and 3% inclusive. It is noted that all proportions by weight are measured on the finished ceramic component (after carrying out the fourth phase of the manufacturing process), or on the unbinded or debinded ceramic powder used. The ALD deposition process is even used to obtain still lower proportions by weight, possibly less than or equal to 5%, but also in particular less than or equal to 2%, or even 1%, or even less than or equal to 0.05%, or even less than or equal to 0.01%. Advantageously, these proportions are greater than or equal to 1 ppm. Advantageously, these proportions are between 1 ppm and 0.01% inclusive, or even between 1 ppm and 0.05% inclusive, or even between 1 ppm and 5% inclusive. Thus, the invention has the advantage of obtaining very interesting results with a small quantity of material, or even a very small quantity of material, without having to prepare a full batch each time, and additionally making it possible to iteratively modify a basic batch.

Moreover, it is important to emphasize that the process of the invention makes it possible to obtain homogeneous distribution or good dispersion of an additional compound, and thus ultimately to obtain a ceramic component of homogeneous color. If the deposition of an additional element is carried out on a ceramic powder, that is to say prior to carrying out the second phase of the process, the ceramic powder enriched in this manner undergoes a sequence of dispersion/grinding steps in the liquid method during the second phase P2, in order to bind it with an organic compound, prior to atomization to turn it into, for example, granules at the end of the second phase P2 of the process. This second phase P2 thus makes it possible to homogeneously distribute the additional compound. As a variant, if the additional compound is deposited after the second phase P2 of the process, that is to say for example directly onto granules, the additional compound is spread over the surface of the granules owing to the deposition process used, and is thus distributed homogeneously over the binded ceramic powder. Thus, the additional compound will be distributed homogeneously in the finished ceramic component.

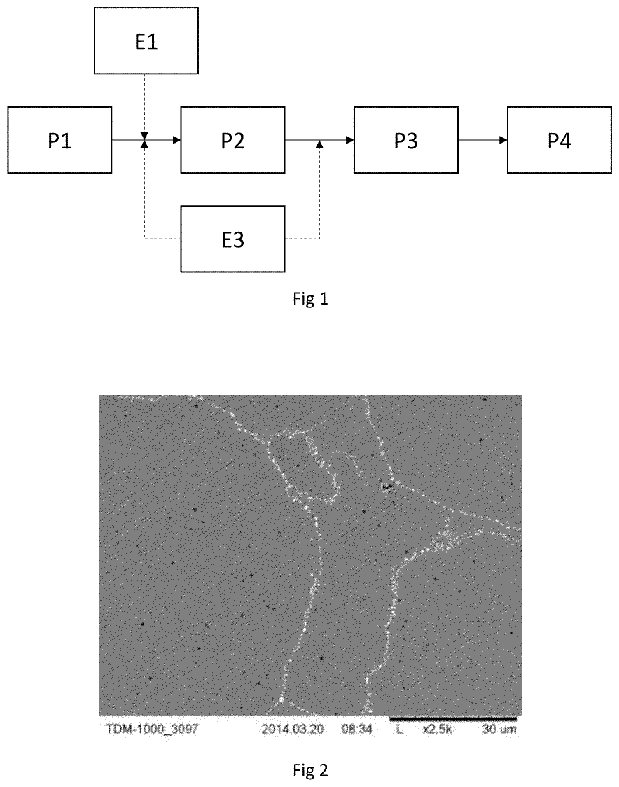

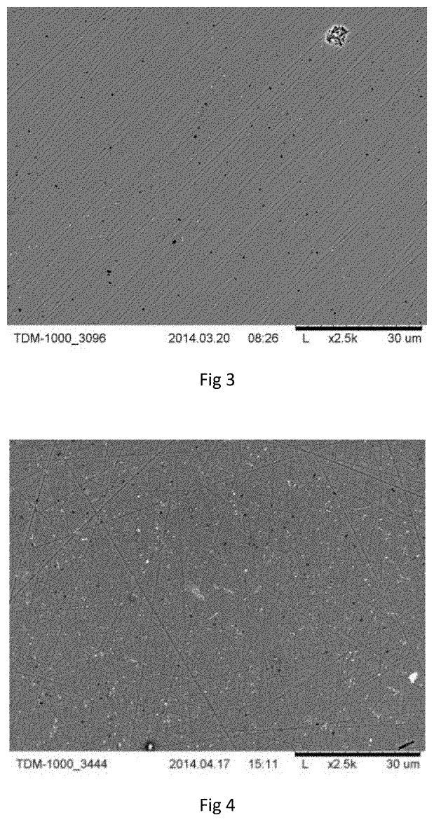

In both of the preceding cases, analysis of the body obtained at the end of the fourth phase shows that the homogeneous distribution of the additional compound is retained in the finished ceramic component. If the PVD deposition has been carried out on the ceramic powder, the final distribution of the particles of additional compound in the ceramic microstructure is random and microscopically homogeneous. If the PVD deposition has been carried out directly onto the pressing granules, the microstructure of the ceramic component exhibits an ordered distribution of the particles of additional compound according to a superstructure that reflects the microstructure of the pressed granules (see FIGS. 2 and 3, which are commented on later in the document). As a variant, this distribution of small particles of additional compound can be perfectly homogeneous by adding an attrition step after the deposition (see FIGS. 4 and 5). In the case of depositions onto the injection feedstock, the homogenization of the distribution of the particles of the additional compound in the material takes place in particular during the step of plasticizing of the molten mixture by the injection screw. Thus, in all cases, the ceramic component comprises an additional element distributed homogeneously in its volume, which allows it to have the property provided by this additional element distributed homogeneously in the ceramic component.

Finally, the deposition step E3 of the embodiment of the invention provides the following principal advantages:
it makes it possible to obtain perfectly controlled and very-low-quantity addition of an additional element or compound, and thus makes it possible to implement microdosage of the additional compound;
it makes it possible to obtain a homogeneous distribution of the additional compound on the surface of the ceramic powder or of the binded ceramic powder, which ultimately means that the ceramic component has homogeneous properties;
it makes it possible to add a multitude of additional compounds, increasing the number of possible additional compounds in comparison to the existing solutions, increasing the possibilities for providing a ceramic component with certain properties;
it permits reliable, repeatable and clean deposition of an additional compound.

The invention is illustrated below by seven examples which make it possible to manufacture a component made of gray ceramic, having hues that are impossible to produce with the traditional techniques. In all of these seven examples, the additional compound is platinum, which is deposited by PVD deposition onto a pressing powder. All of the obtained results, in particular in terms of color, are summarized in the following Table 1.

TABLE 1

| Constituents | | REF1 | 1 | 2 | 3 | 4 | 5 | 6 | 7 |
|---|---|---|---|---|---|---|---|---|---|
| ZrO₂ stab.- TZ3Y | | 99.75 | 97.50 | 99.64 | 97.50 | 99.64 | 99.917 | 99.944 | 99.978 |
| (wt %) | | | | | | | | | |
| Al₂O₃ (wt %) | | 0.25 | 0.24 | 0.25 | 0.24 | 0.25 | 0.008 | 0.006 | 0.002 |
| Pt (wt %) | | 0 | 2.26 | 0.11 | 2.26 | 0.11 | 0.075 | 0.05 | 0.02 |
| CIEL*a*b* | L* | 88.423 | 47.5 | 50.8 | 46.9 | 50.3 | 64.1 | 73 | 83.2 |
| | a* | −1.187 | 0.2 | 0.1 | 0.3 | 0.2 | 0.2 | 0.1 | 0 |
| | b* | −1.567 | −0.2 | −0.9 | 0 | −0.6 | −0.6 | −0.2 | 0.6 |

The first example is based on the use of a binded ceramic powder in the form of granules, containing 3 mol % yttria-stabilized zirconia (TZ3Y) and comprising 0.25% by weight of alumina and 3% by weight of organic binders (REF1). 50 grams of these granules are placed in the vibrating bowl of a PVD chamber containing a platinum cathode. The PVD chamber is evacuated and then the platinum is pulverized with an argon plasma. Inducted coupled plasma (ICP) analysis has made it possible to meter the platinum content of these previously debinded granules. The samples obtained from this example contain, overall, a platinum content of 2.26% by weight. The obtained coated granules are then pressed in a cylindrical mold on a uniaxial press. The resulting pellet is debinded in air at 600° C. for 18 hours. Finally, it is sintered in air at 1450° C. with a dwell time of two hours. After sintering, the faces of the ceramic pellet are rectified then polished. The resulting ceramic component is gray in color. FIG. 2 is an image, obtained by scanning electron microscope, of the obtained ceramic pellet, which shows the distribution of the platinum particles (light dots). This figure makes it possible to highlight the ordered distribution of the platinum particles, in a microscopic superstructure, around the old pressing granules. At the scale of the component, the distribution of the particles is homogeneous.

The second example is created from a binded pressing powder containing 3 mol % yttria-stabilized zirconia (TZ3Y) and comprising 0.25% by weight of alumina and 3% by weight of organic binders, in the form of granules (REF1). 50 grams of these granules are placed in the vibrating bowl of a PVD chamber containing a platinum cathode. The PVD chamber is evacuated and then the platinum is pulverized with an argon plasma. Inducted coupled plasma (ICP) analysis has made it possible to meter the platinum content of these previously debinded granules. The samples of this example contain, overall, a platinum content of 0.11% by weight. The obtained coated granules are then pressed in a cylindrical mold on a uniaxial press. The resulting pellet is debinded in air at 600° C. for 18 hours. Finally, it is sintered in air at 1450° C. with a dwell time of two hours. After sintering, the faces of the pellet are rectified then polished. The resulting ceramic component is gray in color. FIG. 3 is an image, obtained by scanning electron microscope, of the obtained ceramic pellet, which shows the distribution of platinum particles (light dots) at the grain boundaries. At the scale of the component, this distribution is homogeneous. These platinum particles are difficult to see owing to the very low platinum content.

The third example involves removing some of the powder obtained when creating example 1. To this is then added a step of debinding followed by an attrition (mixing, grinding in liquid) and binding treatment. In this treatment, 0.47 g of PVA, 0.71 g of PEG 20 000 and 170 ml of DI (deionized) water are added to 39.4 g of debinded powder from example 1. The resulting suspension is placed into the zirconia bowl of an attritor with 1 kg of zirconia beads to be attrited for 1 hour at 400 revolutions/minute. The suspension is then gathered to be dried and granulated by atomization using a “spray dryer”. The granules obtained in this manner are then pressed in a cylindrical mold on a uniaxial press. The resulting pellet is debinded in air at 600° C. for 18 hours. Finally, it is sintered in air at 1450° C. with a dwell time of two hours. The samples from this example still contain, overall, the same content of 2.26% by weight of platinum as in example 1. After sintering, the faces of the pellet are rectified then polished. The resulting ceramic component is gray in color. FIG. 4 is an image, obtained by scanning electron microscope, of the obtained ceramic pellet, which shows the microscopically homogeneous distribution of platinum particles (light dots) within the zirconia grains. The differences in color between the polished ceramics produced by examples 1 and 3 are visually imperceptible (ΔE<1) and are within the measurement error given by the device; we therefore judge that, to the human eye, the distribution of the particles of platinum in these two samples is identical.

The fourth example involves selecting some of the powder obtained when creating the second example. To this is then added a step of debinding followed by an attrition and binding treatment. In this treatment, 0.46 g of PVA, 0.69 g of PEG 20 000 and 166 ml of DI (deionized) water are added to 38.5 g of debinded powder from example 2. The resulting suspension is placed into the zirconia bowl of an attritor with 1 kg of zirconia beads to be attrited for 1 hour at 400 revolutions/minute. The suspension is then gathered to be dried and granulated by atomization using a “spray dryer”. The granules obtained are then pressed in a cylindrical mold on a uniaxial press. The resulting pellet is debinded in air at 600° C. for 18 hours. Finally, it is sintered in air at 1450° C. with a dwell time of two hours. The samples from this example still contain, overall, the same content of 0.11% by weight of platinum as in example 2. After sintering, the faces of the pellet are rectified then polished. The resulting ceramic component is gray in color. FIG. 5 is an image, obtained by scanning electron microscope, of the obtained ceramic pellet, which shows the microscopically homogeneous distribution of platinum particles (light dots) within the zirconia grains. These platinum particles 2 are difficult to see owing to the very low platinum content. The differences in color between the polished ceramics produced by examples 2 and 4 are visually imperceptible (ΔE<1) and are within the measurement error given by the device; we therefore judge that, to the human eye, the distribution of the particles of platinum in these two samples is identical.

In the fifth example, 3.32 g of the powder obtained when creating the third example is taken and is debinded in order to be mixed with 96.68 g of commercial powder (3 mol % yttria-stabilized zirconia, without binder) before undergoing an attrition treatment. Then, 1.2 g of PVA, 1.8 g of PEG 20 000 and 200 ml of DI (deionized) water are added to 100 g of obtained powder. The resulting suspension is placed into the zirconia bowl of an attritor with 1 kg of zirconia beads to be attrited for 70 minutes at 400 revolutions/minute. The suspension is then gathered to be dried and granulated by atomization using a “spray dryer”. The granules obtained are then pressed in a cylindrical mold on a uniaxial press. The resulting pellet is debinded in air at 600° C. for 18 hours. Finally, it is sintered in air at 1450° C. with a dwell time of two hours. The samples from this example contain a content of 0.075% by weight of platinum. After sintering, the faces of the pellet are rectified then polished. The resulting ceramic component is gray in color.

In the sixth example, 2.21 g of the powder obtained when creating the third example is taken and is debinded in order to be mixed with 97.79 g of commercial powder (3 mol % yttria-stabilized zirconia, without binder) before undergoing an attrition treatment. Then, 1.2 g of PVA, 1.8 g of PEG 20 000 and 200 ml of DI (deionized) water are added to 100 g of obtained powder. The resulting suspension is placed into the zirconia bowl of an attritor with 1 kg of zirconia beads to be attrited for 70 minutes at 400 revolutions/minute. The suspension is then gathered to be dried and granulated by atomization using a “spray dryer”. The granules obtained are then pressed in a cylindrical mold on a uniaxial press. The resulting pellet is debinded in air at 600° C. for 18 hours. Finally, it is sintered in air at 1450° C. with a dwell time of two hours. The samples from this example contain a content of 0.05% by weight of platinum. After sintering, the faces of the pellet are rectified then polished. The resulting ceramic component is gray in color.

In the seventh example, 0.77 g of the powder obtained when creating the third example is taken and is debinded in order to be mixed with 99.23 g of commercial powder (3 mol % yttria-stabilized zirconia, without binder) before undergoing an attrition treatment. Then, 1.2 g of PVA, 1.8 g of PEG 20 000 and 200 ml of DI (deionized) water are added to 100 g of obtained powder. The resulting suspension is placed into the zirconia bowl of an attritor with 1 kg of zirconia beads to be attrited for 70 minutes at 400 revolutions/minute. The suspension is then gathered to be dried and granulated by atomization using a “spray dryer”. The granules obtained are then pressed in a cylindrical mold on a uniaxial press. The resulting pellet is debinded in air at 600° C. for 18 hours. Finally, it is sintered in air at 1450° C. with a dwell time of two hours. The samples from this example contain a content of 0.02% by weight of platinum. After sintering, the faces of the pellet are rectified then polished. The resulting ceramic component is gray in color.

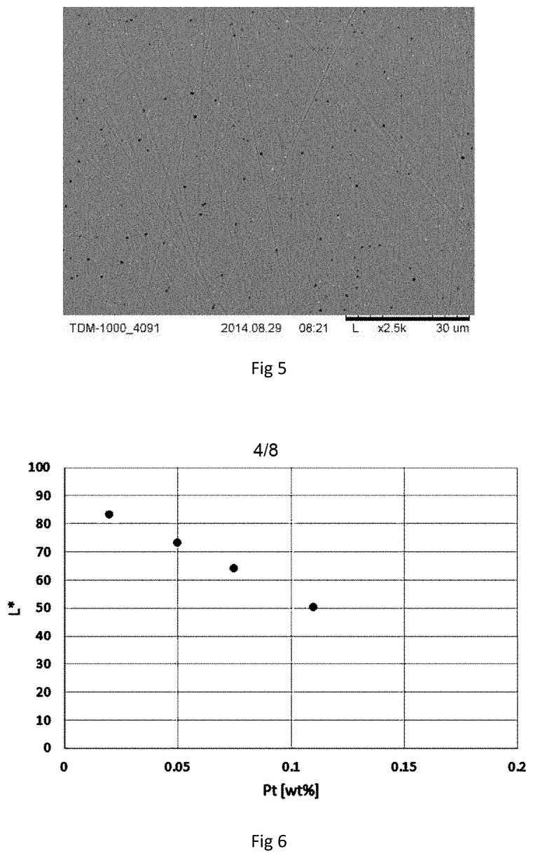

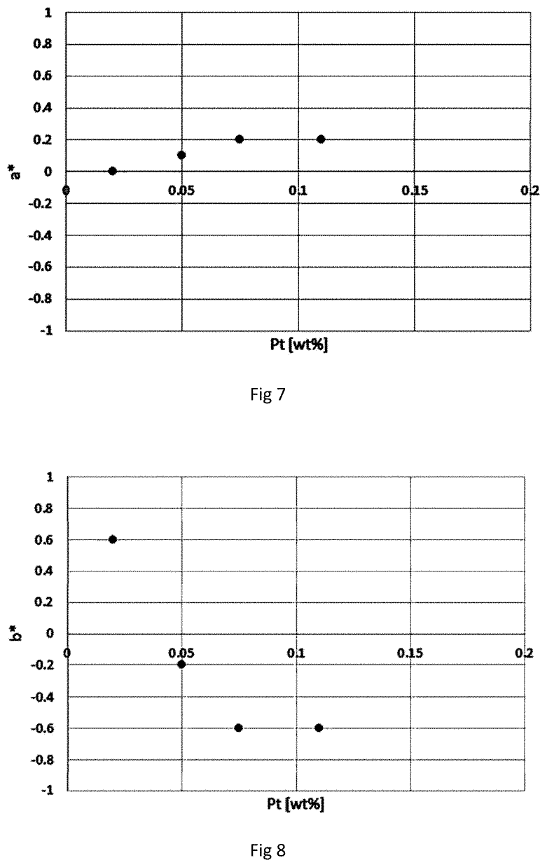

Table 1 shows the results from the seven examples above. It is interesting to note that all of these examples make it possible to obtain a gray ceramic. Thus, in general terms, an embodiment of the invention advantageously makes it possible to manufacture a gray ceramic, characterized by the two parameters a* and b* between −1 and 1 inclusive. Moreover, it is interesting to note that the hue varies depending on the platinum content, as is summarized by FIGS. 6 to 8.

Similarly, the addition of any noble metal that is gray in color in the metallic state, such as rhodium, osmium, palladium, ruthenium or iridium, will darken an initially white ceramic without any interactions between these additional metals and the constituents of the ceramic producing chromatic pigments which would distance us from the L* axis of the CIELab space.

It is noted that the attrition after addition of the platinum makes it possible to better distribute the platinum in the material (see FIGS. 2 to 5) and does not significantly change the color of the ceramic obtained in these examples. It is also noted that the attrition is linked to a very slight increase in the density of the samples. However, this attrition remains optional.

Of course, the invention is not limited to the manufacture of a ceramic component containing platinum as the additional compound. It is possible to obtain a gray color with an additional compound other than platinum, for example with rhodium, palladium or any other gray noble metal that does not react with the other components of the ceramic or the sintering atmosphere.

Thus, as a variant, other embodiments of the invention may make it possible to manufacture a component made of gray ceramic that is characterized by an L* component below 96 and both the a* and b* parameters between −3 and 3 inclusive, or even between −2 and 2 inclusive, or even between −0.5 and 0.5.

Optionally, the manufacturing method may comprise a preliminary step E1 of adding another compound to the ceramic powder, for example the addition of coloring pigments or any other compound according to the traditional approach mentioned previously, or according to other techniques known to a person skilled in the art, for example by impregnation. Indeed, the invention remains compatible with all of the other existing processes, and can be a complement, for example in order to enhance it. This step E1 may be carried out at any suitable moment in the manufacturing process. It can be carried out before or after step E3.

As mentioned previously, the solution of the prior art for coloring a ceramic component is complex and unsatisfactory. Moreover, if one wishes to change a hue, even slightly, of a ceramic component previously colored using pigments according to the prior art, this proves to be very difficult using the traditional technique, in particular since the pigments have a tendency to react with one another during sintering. Thus, according to the prior art, the process of changing the intensity (clarity) and/or the hue of the coloring of a colored ceramic is long and laborious: indeed, each attempt requires the production of a new batch of ceramic powder, then the production of an injection feedstock, and up to the creation of the finished (sintered and polished) ceramic components.

With the process of the invention, it becomes much easier to carry out such a modification of color or intensity. More generally, it becomes easy to carry out any other modification of a property of the ceramic component.

Thus, one embodiment of the invention rests on a process for manufacturing a ceramic powder or a ceramic component, in particular based on zirconia and/or alumina and/or strontium aluminate, which comprises the following steps:
obtaining a binded ceramic powder containing coloring pigments or more generally at least one added or additional compound by means of which it is possible to obtain a ceramic component of a first color, or more generally provided with a first property, by manufacturing a ceramic component using this binded ceramic powder;
depositing E3, onto said binded ceramic powder, at least one additional coloring or other element or compound, by physical vapor deposition (PVD) or by chemical vapor deposition (CVD) or by atomic layer deposition (ALD);
completing the manufacture of the ceramic component using the binded ceramic powder including the deposited additional compound in order to obtain a ceramic component whose color is a second color, different from the first color, or more generally provided with a second property that is different from the first property.

By means of such a process, a first property obtained from a commercial binded ceramic powder can easily be modified to a second property by adding an additional compound according to an embodiment of the invention. As this embodiment of the invention implements a step E3 that is simple to implement, to control and to reproduce, it becomes easy to carry out multiple tests to obtain, by trial and error, the desired final property for the ceramic component, without this requiring laborious intervention at the stage of preparing an unbinded or debinded ceramic powder.

Thus, the process for manufacturing a ceramic component may repeat steps of depositing at least one additional compound onto said binded ceramic powder, modifying the content of said additional compound, or even the additional compound itself, and of completing the manufacture of the ceramic component, until one has come sufficiently close to the desired result.

In practice, it is therefore possible to implement a step of selecting a binded ceramic powder containing coloring pigments making it possible to obtain a first color close to a desired second color, then to modify the color by adding an additional coloring compound, until one has come sufficiently close to the desired color. The same approach can be implemented for modifying any property other than color, as mentioned previously.

Advantageously, the at least one additional compound is chosen such that it does not react with those added compounds that are already present in the binded ceramic powder, for example coloring pigments.

The pigments present in the binded ceramic powder may comprise one or more elements from among a metal oxide, a rare earth oxide, a cobalt aluminate and/or phosphorescent pigments.

The following three examples, numbered examples eight to ten, illustrate this principle, in the case of a ceramic component containing a cobalt aluminate (blue pigment). The results are presented in the following Table 2.

In the eighth example, a ceramic component is initially colored starting from a commercial ceramic powder of 3 mol % yttria-stabilized zirconia (TZ3Y) containing 0.25% by weight of alumina, to which has been added a quantity of 3% by weight of organic binders and 1% by weight of CoAl₂O₄ pigment by the conventional wet method (REF2). The resulting suspension is dried and granulated by atomization. The granules are then pressed to obtain a sample. This sample is debinded and sintered to obtain a ceramic component that is blue in color, characterized by the following CIE L*a*b* parameters (50.5; −0.7; −19.4).

According to the embodiment of the invention, the binded ceramic powder described above is first debined. Then, 1 g of the debinded powder of the previously described first example is added to 99 g of this debinded ceramic powder. Then, 1.2 g of PVA, 1.8 g of PEG 20 000, and 200 ml of DI water are added to 100 g of this modified ceramic powder. The resulting suspension is placed into the zirconia bowl of an attritor with 1 kg of zirconia beads to be attrited for 70 minutes at 400 revolutions/minute. The suspension is then gathered to be dried and granulated by atomization using a “spray dryer”. The granules obtained are then pressed in a cylindrical mold on a uniaxial press. The resulting pellet is debinded in air at 600° C. for 18 hours. Finally, it is sintered in air at 1450° C. with a dwell time of two hours, according to a cycle known to a person skilled in the art. The samples from this eighth example contain 0.02% by weight of platinum. After sintering, the faces of the pellet are rectified then polished. The modified color is then assessed as shown in the following Table 2.

TABLE 2

| Constituents | | REF2 | 8 | REF3 | 9 | 10 |
|---|---|---|---|---|---|---|
| ZrO₂ stab.- TZ3Y (wt %) | | 99 | 98.98 | 99.5 | 99.48 | 99.464 |
| CoAl₂O₄ (wt %) | | 1 | 1 | 0.5 | 0.5 | 0.5 |
| Pt (wt %) | | 0 | 0.02 | 0 | 0.02 | 0.036 |
| CIEL*a*b* | L* | 50.5 | 48.8 | 52.0 | 50.2 | 49.3 |
| | a* | −0.7 | −1.7 | −1.9 | −1.8 | −1.5 |
| | b* | −19.4 | −12.6 | −15.5 | −9.9 | −7.8 |

The ninth example first considers the manufacture of a 3 mol % yttria-stabilized zirconia (TZ3Y) powder containing 3% by weight of organic binders and 0.5% by weight of CoAl₂O₄ pigments integrated by the conventional wet method (REF3). The resulting suspension is dried and granulated by atomization. The granules are then pressed to obtain a sample. This sample is debinded and sintered. The obtained ceramic is blue in color, having the CIE L*a*b* parameters (52.0; −1.9; −15.5).

Then, the granules used to manufacture this zirconia-based ceramic component are debinded. 1 g of the debinded powder of the first example is added to 99 g of this debinded ceramic powder. Then, 1.2 g of PVA, 1.8 g of PEG 20 000, and 200 ml of DI water are added to these 100 g of mixed powder. The resulting suspension is placed into the zirconia bowl of an attritor with 1 kg of zirconia beads to be attrited for 70 minutes at 400 revolutions/minute. The suspension is then gathered to be dried and granulated by atomization using a “spray dryer”. The granules obtained are then pressed in a cylindrical mold on a uniaxial press. The resulting pellet is debinded in air at 600° C. for 18 hours. Finally, it is sintered in air at 1450° C. with a dwell time of two hours. The samples from this ninth example contain 0.02% by weight of platinum. After sintering, the faces of the pellet are rectified then polished. The ceramic component thus has a modified color (see parameters listed in Table 2).

In the tenth example, a ceramic component is formed from a commercial 3 mol % yttria-stabilized zirconia (TZ3Y) powder containing 0.25% by weight of alumina, containing 3% by weight of organic binders and 0.5% by weight of CoAl₂O₄ pigment, added by the conventional wet method (REF3). The resulting suspension is dried and granulated by atomization. The granules are then pressed to obtain a sample. This sample is debinded and sintered. The obtained ceramic is blue in color, having the CIE L*a*b* parameters (52.0; −1.9; −15.5).

According to the embodiment, the granules used to manufacture the above-mentioned ceramic component are first debinded. Then, 1.8 g of the debinded ceramic powder of example 1 are added to 98.2 g of this debinded ceramic powder. Then, 1.2 g of PVA, 1.8 g of PEG 20 000, and 200 ml of DI water are added to 100 g of the modified ceramic powder. The resulting suspension is placed into the zirconia bowl of an attritor with 1 kg of zirconia beads to be attrited for 70 minutes at 400 revolutions/minute. The suspension is then gathered to be dried and granulated by atomization using a “spray dryer”. The granules obtained are then pressed in a cylindrical mold on a uniaxial press. The resulting pellet is debinded in air at 600° C. for 18 hours. Finally, it is sintered in air at 1450° C. with a dwell time of two hours. The samples from this tenth example then contain 0.036% by weight of platinum. After sintering, the faces of the pellet are rectified then polished. The ceramic component thus has a modified color (see parameters listed in Table 2).

The three examples above are based on the use of the embodiment of the invention to easily achieve a desired color, starting from a pigmented ceramic powder whose color is ultimately modified.

More generally, the embodiment of the invention is easily compatible with all other techniques of adding at least one compound to a ceramic powder. Thus, the invention may be combined with any other technique, in particular with a traditional approach, to obtain any type of ceramic having novel properties.

By way of example, an eleventh example considers a ceramic powder of 3 mol % yttria-stabilized zirconia, to which has been added a quantity of 30% by weight of luminescent pigment Sr₄Al₁₄O₂₅:Dy,Eu and 3% by weight of organic binders by the conventional wet method (REF4). The resulting suspension is dried and granulated by atomization. The granules are pressed, debinded in air and sintered at 1450° C. for 2 hours under a particular atmosphere. This traditional process makes it possible to obtain a ceramic of color defined by CIE L*a*b* parameters (94.0; −4.7; 6.7).

As a variant combining an embodiment of the invention, the granules of the composite ceramic powder used above are debinded. Then, 1 g of the debinded powder from the first example is added to 99 g of this powder. Then, 1.2 g of PVA, 1.8 g of PEG 20 000, and 200 ml of DI water are added to 100 g of the obtained powder. The resulting suspension is placed into the zirconia bowl of an attritor with 1 kg of zirconia beads to be attrited for 70 minutes at 400 revolutions/minute. The suspension is then gathered to be dried and granulated by atomization using a “spray dryer”. The granules obtained are then pressed in a cylindrical mold on a uniaxial press. The resulting pellet is debinded in air at 600° C. for 18 hours. Finally, it is sintered at 1450° C. with a dwell time of two hours under a particular atmosphere. The samples from this eleventh example contain 0.02% by weight of platinum. After sintering, the faces of the pellet are rectified then polished. The result is thus a colored and luminescent ceramic component, obtained by combining the invention with a traditional process, the precise characteristics of which are summarized in the following Table 3.

TABLE 3

| | | |
|---|---|---|
| Constituents | REF4 | 11 |

| ZrO₂ stab.- TZ3Y (wt %) | | 70 | 69.98 |
|---|---|---|---|
| Sr₄Al₁₄O₂₅:Dy, Eu (wt %) | | 30 | 30 |
| Pt (wt %) | | 0 | 0.02 |
| CIEL*a*b* | L* | 94.0 | 49.3 |
| | a* | −4.7 | 0.4 |
| | b* | 6.7 | 2.5 |

As a variant, such a phosphorescent ceramic component might be given other colors by adding other additional compounds or elements.

Below further examples allow the manufacture of a gray ceramic component, having hues that are impossible to produce with the traditional techniques. The additional compound is platinum, which is deposited by ALD deposition onto an unbinded powder. All of the obtained results, in particular in terms of color, are summarized in Table 1.

By way of example, a first example considers a ceramic powder of 3 mol % yttria-stabilized zirconia (TZ3YS). 10 g of such powder are placed in the vibrating bowl of an ALD chamber, which is evacuated, so that platinum deposition is engaged through ALD process. 50 deposition cycles are performed.

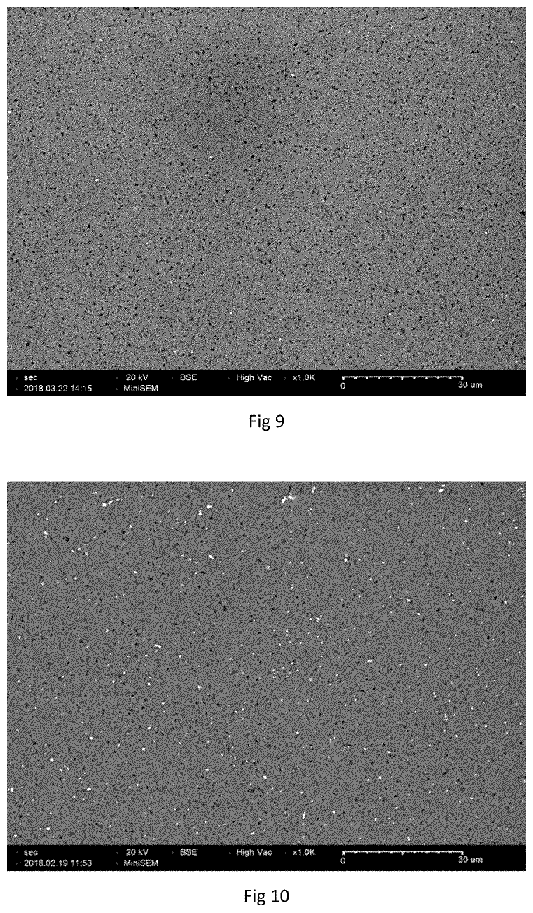

The obtained coated ceramic powder follows a step of attrition (mixing, grinding in liquid) and binding treatment. In this treatment, 0.6 g of PVA, 0.9 g of PEG 20 000 and 116 ml of DI (deionized) water are added to 50.4 g of said ceramic powder, covered by platinum. The resulting suspension is placed into the zirconia bowl of an attritor with 1 kg of zirconia beads to be attrited for 2 hours at 400 revolutions/minute. The suspension is then gathered to be dried and granulated by atomization using a “spray dryer”. The granules obtained in this manner are then pressed in a cylindrical mold on a uniaxial press. The resulting pellet is debinded in air at 600° C. for 18 hours. Finally, it is sintered in air at 1450° C. with a dwell time of two hours. After sintering, the faces of the ceramic pellet are rectified then polished. The resulting ceramic component is gray in color. FIG. 9 is an image, obtained by scanning electron microscope, of the obtained sintered ceramic pellet, which shows the distribution of the platinum particles (light dots). This figure makes it possible to highlight the homogeneous distribution of the platinum particles. Indeed, at the scale of the component, the distribution of the particles is considered as homogeneous. The resulting color appears homogeneous to the naked eye. The color and the composition are indicated under reference 1 ALD 50 in the following Table 4.

A second example considers an unbinded ceramic powder of 3 mol % yttria-stabilized zirconia (TZ3YS). 10 g of such powder are placed in the vibrating bowl of an ALD chamber, which is evacuated, so that platinum deposition is engaged through ALD process. 200 deposition cycles are performed. To this is then added a step of debinding followed by an attrition (mixing, grinding in liquid) and binding treatment. In this treatment, 0.6 g of PVA, 0.9 g of PEG 20 000 and 120 ml of DI (deionized) water are added to 50.4 g of said ceramic powder, covered by platinum. The resulting suspension is placed into the zirconia bowl of an attritor with 1 kg of zirconia beads to be attrited for 2 hours at 400 revolutions/minute. The suspension is then gathered to be dried and granulated by atomization using a “spray dryer”. The granules obtained in this manner are then pressed in a cylindrical mold on a uniaxial press. The resulting pellet is debinded in air at 600° C. for 18 hours. Finally, it is sintered in air at 1450° C. with a dwell time of two hours. After sintering, the faces of the ceramic pellet are rectified then polished. The resulting ceramic component is gray in color. FIG. 10 is an image, obtained by scanning electron microscope, of the obtained sintered ceramic pellet, which shows the distribution of the platinum particles (light dots). This figure makes it possible to highlight the homogeneous distribution of the platinum particles. Indeed, at the scale of the component, the distribution of the particles is considered as homogeneous. The resulting color appears homogeneous to the naked eye. The color and the composition are indicated under reference 1 ALD 200 in the following Table 4.

TABLE 4

| Constituents | | REF1 | 1-ALD 50 | 2-ALD 200 |
|---|---|---|---|---|
| ZrO₂ stab.- TZ3Y (wt %) | | 99.75 | 99.62 | 98.75 |
| Al₂O₃ (wt %) | | 0.25 | 0.25 | 0.25 |
| Pt (wt %) | | 0 | 0.13 | 1.0 |
| CIEL*a*b* | L* | 47.7 | 46.1 | 75.05 |
| | a* | 0.7 | 0.4 | 0.19 |
| | b* | 0.5 | 0 | −0.29 |

Table 4 represents the results of above two interesting to note that all of these examples make it possible to obtain a gray ceramic. Thus, in general terms, an embodiment of the invention advantageously makes it possible to manufacture a gray ceramic, Accordingly, more generally, an embodiment of the invention allows advantageously to manufacture a gray ceramic, characterized by the two parameters a* and b* between −1 and 1 inclusive.

The coloring of a ceramic component is of particular importance for a timepiece or jewelry piece because it makes it possible to obtain a desired esthetic. Thus, the invention is of particular interest for manufacturing a horological component, or a jewelry component. This horological component may in particular be a watch bezel, a dial, an index, a winding crown, a button or any other horological fitting element or element of a horological movement. The invention also relates to a timepiece, in particular a watch, comprising such a horological component.

1-14. (canceled)

15. A ceramic powder comprising:
at least 50% by weight of at least one ceramic selected from the group consisting of zirconia, alumina, and strontium aluminate,
at least one noble metal selected from the group consisting of platinum, rhodium, osmium, palladium, ruthenium and iridium,
optionally, at least one organic compound,
wherein the at least noble metal is present at a quantity of less than or equal to 3% by weight, not considering any organic compound or compounds,
wherein the ceramic powder comprises particles of the ceramic at least partially coated with the noble metal,
wherein the coating of the noble metal on the at least partially coated particles results from at least one deposition selected from the group consisting of physical vapor deposition (PVD), chemical vapor deposition (CVD), and atomic layer deposition (ALD) on ceramic particles,
wherein the ceramic powder is adapted to form by sintering a sintered ceramic comprising sintered particles of the ceramic and particles of the noble metal and having reliable and repeatable coloration properties.

16. The ceramic powder as claimed in claim 15, wherein the ceramic particles comprise atomized granules formed by clusters of binded particles of the ceramic powder, wherein the clusters are adapted for pressing to form a shape of the ceramic component before sintering.

17. The ceramic powder as claimed in claim 15, comprising, in addition to the at least one noble metal, one or more coloring pigments distinct from the at least one noble metal.

18. The ceramic powder as claimed in claim 15, which is a binded powder.

19. The ceramic powder as claimed in claim 15, wherein the at least one ceramic is selected from the group consisting of alumina and zirconia.

20. The ceramic powder as claimed in claim 15, wherein the at least one ceramic is zirconia.

21. The ceramic powder as claimed in claim 15, wherein the at least one noble metal is present in a quantity of from 10 ppm to 2% by weight.

22. The ceramic powder as claimed in claim 15, wherein the at least one noble metal is present in a quantity of from 0.01% by weight to 1% by weight.

23. The ceramic powder as claimed in claim 15, wherein the particles of the ceramic at least partially coated with the coating of the noble metal result from attrition of coated ceramic particles.

24. The ceramic powder as claimed in claim 15, wherein the at least one noble metal is present in a quantity of less than or equal to 2.26% by weight.

25. The ceramic powder as claimed in claim 15, wherein the at least one noble metal is present in a quantity of greater than or equal to 1 ppm.

26. The ceramic powder as claimed in claim 15, wherein the at least one noble metal is adapted to lend a ceramic component obtained by sintering the ceramic powder a gray color defined by the color coordinates a* and b* of values contained in the range [−3; 3].

27. The ceramic powder as claimed in claim 15, comprising coloring pigments that are distinct from and in addition to the at least one noble metal.

28. The ceramic powder as claimed in claim 15, wherein the ceramic powder comprises a plurality of noble metals each selected from the group consisting of platinum, rhodium, osmium, palladium, ruthenium and iridium.

29. The ceramic powder as claimed in claim 15, wherein the ceramic powder comprises the at least one noble metal in the form of a metal alloy comprising the at least one noble metal.

30. A method of fabricating a sintered ceramic component, comprising:
providing the ceramic powder as claimed in claim 29, and
sintering the ceramic powder, so as to obtain the sintered ceramic component comprising sintered particles of the ceramic and particles of the noble metal and having reliable and repeatable coloration properties.

31. The method as claimed in claim 30, comprising forming a feedstock of binded particles of the ceramic powder, wherein the feedstock is adapted for injecting to form a shape of the ceramic component before sintering.

32. The method as claimed in claim 30, comprising forming a slurry of binded particles of the ceramic powder in a suspension, wherein the suspension is adapted for casting to form a shape of the ceramic component before sintering.

33. The method as claimed in claim 30, wherein the ceramic component has a gray color with color coordinates a* and b* of values contained in the range [−3; 3].

34. The method as claimed in claim 30, wherein the ceramic component is selected from the group consisting of a watch bezel, a dial, an index, a winding crown, and a button.
